(19) United States
(12) Patent Application Publication
(10) Pub. No.: US 2021/0123005 A1
(43) Pub. Date: Apr. 29, 2021

(54) METHOD AND DEVICE FOR PRESERVING WINE-CONTAINING LIQUIDS

(71) Applicant: LANXESS DEUTSCHLAND GMBH, Cologne (DE)

(72) Inventors: Erasmus VOGL, Bergisch-Gladbach (DE); Ermin TUTIC, Hamm (DE)

(73) Assignee: LANXESS Deutschland GmbH, Cologne (DE)

(21) Appl. No.: 17/040,199

(22) PCT Filed: Feb. 8, 2019
(86) PCT No.: PCT/EP2019/053126

§ 371 Date: Sep. 22, 2020

(30) Foreign Application Priority Data
Mar. 22, 2018 (EP) 18163370.2

(51) Int. Cl. C12H 1/14; B01F 5/04; B01F 5/10; C12L 11/00

(52) U.S. Cl. CPC C12H 1/14; C12L 11/00; B01F 5/106; B01F 5/0413

(57) ABSTRACT

The invention relates to a method and a device for preserving wine-based beverages and to use of the device for this purpose.

The invention relates to a method and a device for preserving wine-based beverages and to use of the device for this purpose.

Preservatives, such as e.g. dicarbonate diesters, sulphur dioxide, natamycin, benzoates or sorbates are used in the beverage industry for cold sterilization of alcohol-free carbonated or non-carbonated fruit juice drinks, fruit juices, wines, alcohol-free wines, ciders, iced teas and other beverages. A particular type of cold sterilization agents are the dicarbonate diesters, such as in particular dimethyl dicarbonate or diethyl dicarbonate, which offer a series of advantages. Their outstanding advantage is that unlike in the case of hot sterilization, they have no effect on taste or colour. A particular advantage compared to long-lasting preservatives such as sodium benzoate, benzoic acid, potassium sorbate or sorbic acid is that they do not impair taste and their action is temporary. Because the dicarbonate diesters decompose into harmless components, the actual user does not consume any preservatives.

Another particularly well-known advantage of use of dicarbonate diesters compared to cold sterile filling is that they allow a substantial reduction in investment costs in plant technology.

According to the prior art, on-line dosing pumps are exclusively used for adding dicarbonate diesters. These systems are composed of a temperature-controlled stainless steel cabinet, a mechanically driven membrane pump, storage and buffer vessels, a device attached to the beverage line for atomization with a mixing tube, a flow meter installed in the beverage line, and an electronic control and storage unit. Dosing pumps of this type are usually permanently installed in the beverage line.

The mode of operation of these devices is based on online measurement of the beverage flow rate prevailing in the beverage tube and the amount of dicarbonate diesters, which is calculated in parallel from said rate. The dicarbonate diesters are therefore added in the required amount to the beverage tube in a precisely-dosed manner in each case.

In the treatment of wine-based beverages, in particular wine or mixed wine beverages, in particular in the treatment of wine in casks during aging, cold sterilization treatment with dicarbonate diesters can be necessary, for example in order to combat Brettanomyces yeasts in the wine. In this treatment, a second vessel is ordinarily used that is at least of equal capacity in order to take up the recirculated amount of liquid. On-line dosing pumps are ordinarily used for dosing of the cold sterilization agent in this method as well. As the on-line dosing pumps have start-up and shut-down periods, overfilling or underfilling of the second vessel is frequently seen, in particular with loss of the beverage. Moreover, on-line dosing pumps are relatively expensive. The set-up requires special transportation devices, and connection requires a sufficient amount of time.

There is therefore a need for a method of preserving wine-based beverages, in particular wine or mixed wine beverages, by means of which the drawbacks of the prior art can be overcome.

Surprisingly, a method has now been found that can be carried without using on-line dosing pump systems and by means of which the loss of wine-based beverages in treatment of such beverages with preservatives can be reduced and a high degree of mixing can be simultaneously achieved. In addition, the method is more economical that the methods used in the past for preserving wine-based beverages.

The subject matter of the invention is therefore a method for preserving a wine-based beverage, comprising a vessel, at least one line, by means of which the wine-based beverage is pumped from the vessel using a pump, and at least one storage vessel comprising at least one preservative, wherein the preservative is supplied to the wine-based beverage in the line and this mixture is pumped into the same vessel.

Wine-based beverages within the meaning of the invention are preferably wine and mixed wine beverages that can additionally contain up to 90 wt % of water based on the total weight of the wine-based beverage. The wine-based beverages are particularly preferably wine and mixed wine beverages. The wine and mixed wine beverages can contain alcohol or be alcohol-free. Wine within the meaning of the invention is an alcohol-containing or alcohol-free beverage obtained from fermented grape juice. Preferably, the wine within the meaning of the invention contains 7 wt % to 18 wt % ethanol based on the total weight of the wine.

Mixed wine beverages are preferably mixtures of white wine, red wine, rosé wine, and fruit juice and/or flavouring components. Mixed wine beverages preferably contain 1 wt % to 50 wt % wine and 99 wt % to 50 wt % fruit juices based on the total weight of the mixed wine beverages, and particularly preferably, mixed wine beverages contain 5 wt % to 30 wt % wine and 95 wt % to 70 wt % fruit juices based on the total weight of the mixed wine beverages.

The vessel is preferably a cask or a tank. The vessel is preferably composed of metal or wood. Particularly preferably, the vessel is composed of wood. In a preferred embodiment of the invention, the vessel has a height of 85 to 100 cm and a diameter of 65 to 75 cm at the middle of the cask. Particularly preferably, the vessel has a height of 90 cm to 100 cm and a diameter of 60 cm to 70 cm at the middle of the cask.

In a further preferred embodiment of the invention, the vessel has a volume of 100 l to 2,000 l, particularly preferably 200 l to 500 l and most particularly preferably 200 l to 300 l.

The lines can be metal tubes or rubber or plastic tubes. Preferably, the lines are composed partially of metal tubes at the inlet and outlet and partially of plastic tubes for the connecting areas. Particularly preferably, metal tubes are used as lines. Preferably, the metal tubes are composed of stainless steel. The lines preferably have a diameter of 2 cm to 7 cm. Both line openings, that of the inlet that leads into the vessel and that of the outlet that leads out of the vessel, preferably extend into the wine-based beverage in the vessel. The vessel can also be only partially filled with the wine-based beverage. The position of the inlet can be adjusted by positioning of the line so that the line extends into the wine-based beverage. The position of the outlet can also be adjusted by positioning of the line. The locations of the inlet and the outlet of the lines in the vessel are preferably at a distance of at least 5 cm from each other based on the distance between the centres of the openings of the lines, and particularly preferably at least 10 cm to 20 cm from each other based on the distance between the centres of the openings of the lines.

Static or dynamic mixers are preferably positioned at the openings of the lines.

As a pump within the meaning of the invention, a type of liquid pump is generally suitable, such as e.g. centrifugal, gear, membrane, helical, liquid, positive displacement, screw or piston pumps. Within the meaning of the invention, a self-priming pump is preferably used. These are pumps that do not need to be pre-filled with the liquid medium to be pumped on start-up, can thus start up empty, and because of this capacity, can develop a suction action even when dry and independently aspirate the medium.

In a preferred embodiment, the pump is a food-grade electrically operated pump for liquids. The pump preferably has a capacity of 10 l/min to 50 l/min. Particularly preferably, the pump has a capacity of >50 l/min. The inlet and outlet of the pump are ordinarily connected to the lines via suitable elastic tubes. In a further embodiment according to the invention, an immersion pump is used. The immersion pump is preferably installed at the inlet or outlet of the lines.

The storage vessel serves as a receiving and storage tank for the preservatives. The preservative is preferably aspirated from the storage vessel into the line via a capillary tube. An injector integrated into the storage vessel is preferably used for this purpose. Preferably, a Venturi nozzle is used as an injector. Alternatively, the injector can also consist of a flexibly installed screw thread into which the vessel containing the preservative is screwed and which can then be turned upside down by manually turning or inverting it in order to cause the preservative, in particular the dicarbonate diesters, to flow in.

Switching on of the injector is preferably made possible by activating an interposed valve.

It is preferable for the pump to be positioned in the line downstream of the storage vessel in the flow direction of the wine-based beverage. The distance between the storage vessel and the pump is then preferably not more than 50 cm. In this way, thorough mixing of the wine-based beverage and the preservative in the line is also promoted.

Preservation is carried out against microorganisms, such as e.g. bacteria and fungi. Preservation is preferably carried out against fungi. In the context of the invention, the term preservation therefore comprises sterilization, i.e. a case in which microorganisms are already present in the wine-based beverages before the preservatives are added. In this case, the preservatives also act as sterilizing agents.

Preferably used as preservatives are dicarbonate diesters, e.g. particularly preferably dimethyl dicarbonate and diethyl dicarbonate, sulphur dioxide and/or sulphur dioxide-releasing substances, such as preferably sodium disulphite, potassium hydrogen sulphite, potassium disulphite, calcium hydrogen sulphite, calcium disulphite, potassium disulphite or mixtures of these salts, or sorbic acid, benzoic acid and salts of these acids, e.g. preferably sodium sorbate, potassium sorbate, calcium sorbate, magnesium sorbate, sodium benzoate, potassium benzoate, lithium benzoate, calcium benzoate, magnesium benzoate and lithium sorbate or mixtures of these salts. Dicarbonate diesters are particularly preferred, and dimethyl dicarbonate is most particularly preferred for use as a preservative.

Preferably, 0.1 ppm to 250 ppm of preservatives are used based on the volume of the wine-based beverage. Particularly preferably, 1 ppm to 250 ppm of preservatives are used based on the volume of the wine-based beverage.

Preferably, dicarbonate diesters are then used as a preservative. Particularly preferably, 1 to 250 ppm of dicarbonate diesters are used as a preservative based on the volume of the wine-based beverage.

In a further embodiment of the invention, between 16 ml and 40 ml of dicarbonate diesters are preferably used for a volume of wine-based beverages of between 200 l and 500 l.

In a further embodiment of the invention, 8 ml to 80 ml of dicarbonate diesters are particularly preferably used for 100 l to 2,000 l of the wine-based beverage.

Preferably, the method according to the invention is carried out such that the wine-based beverage is pumped from the vessel into the line. The line opening for the outlet and the line opening for the inlet are preferably at a distance of at least 5 cm from each other so that improved mixing can be carried out. The wine-based beverage then preferably flows past the storage vessel, preferably by means of an injector. The preservative is preferably supplied to the wine-based beverage in this process. The preservative can be added discontinuously, i.e. batch-wise, or continuously. Addition is preferably carried out continuously. Preferably, thorough mixing is carried out using a Venturi nozzle in the line. This is preferably followed by further mixing in the pump, preferably by turbulent vortexing. Further additives, such as e.g. sweeteners, could also be added to the wine-based beverage. These additives are preferably stored in additional storage vessels. In addition, further supply lines can be attached for connecting the pump or the storage vessels. The wine-based beverage, which with the preservatives have been mixed, is then returned to the same vessel.

The wine-based beverage is preferably completely recirculated at least once. Preferably, the wine-based beverage is completely recirculated at least five times. The term “recirculate” within the meaning of the invention means that the contents of the vessel are completely exchanged. The preservative is preferably completely added during the first recirculation process. Preferably, there is no further addition of preservatives during further recirculation processes.

Preferably, the pumping process is carried out for a period of 5 min to 20 min. Particularly preferred is a period of 10 min to 15 min.

The invention also comprises a device for carrying out the method according to the invention comprising a vessel, at least one line, at least one pump and at least one storage vessel comprising at least one preservative, wherein the preservative is supplied to the wine-based beverage in the line and this mixture is pumped into the same vessel.

The invention also comprises use of the device according to the invention for preserving wine-based beverages, in particular wine and mixed wine beverages.

The invention is explained in further detail in the following with reference to the figures, without limiting the general concept of the invention.

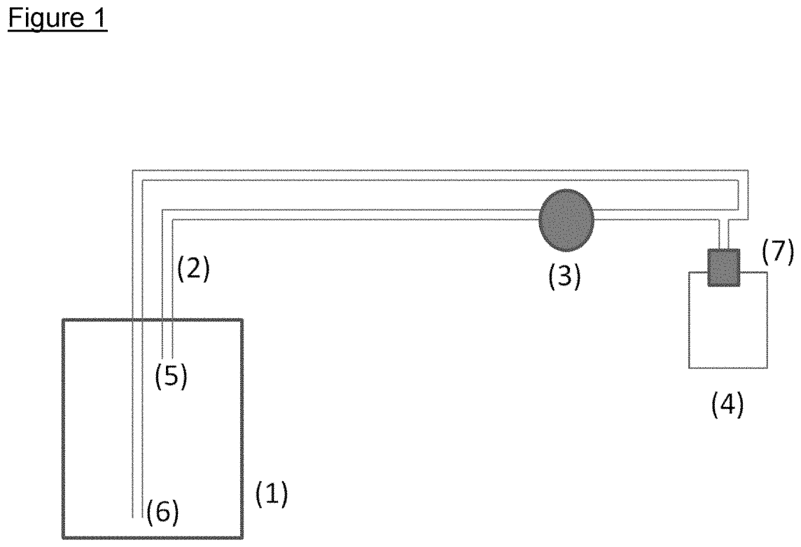

FIG. 1 shows a general structure of the device according to the invention.

FIG. 1 shows a device according to the invention for preserving a wine-based beverage, comprising a vessel (1), at least one line (2), into which the wine-based beverage is pumped from the vessel by means of a pump (3), and at least one storage vessel (4) comprising at least one preservative, characterized in that the preservative is supplied to the wine-based beverage and this mixture is again pumped into the same vessel (1).

Preferably, the preservative is added by means of an injector (7) from the storage vessel (4). Preferably, injection is carried out via a Venturi nozzle due to the negative pressure in the line (2) produced by the pump. In this case, therefore, the wine-based beverage and the preservative are thoroughly mixed via this nozzle.

FIG. 1 also shows the method for preserving a wine-based beverage, comprising a vessel (1), at least one line (2), by means of which the wine-based beverage is pumped from the vessel (1) by means of a pump (3), and at least one storage vessel (4) comprising at least one preservative, wherein the preservative is supplied to the wine-based beverage and this mixture is pumped into the same vessel (1).

In a further preferred embodiment of the invention, the method is carried out such that the line opening of the inlet (5), from which the mixture of preservatives and wine-based beverage flows back into the vessel, and the line opening of the outlet (6) are both located in the wine-based beverage.

In a further preferred embodiment of the invention, the method is carried out such that the line opening of the inlet (5), from which the mixture of preservatives and wine-based beverage flows back into the vessel, and the line opening of the outlet (6), both of which are located in the wine-based beverage, are at a distance of at least 5 cm from each other, based on the distance between the centres of the openings of the lines.

The device according to the invention makes it possible to efficiently treat wine-based beverages in vessels, in particular with a high volume, such as e.g. in tanks or casks, against contamination by microorganisms. Technically complex systems can be dispensed with, thus allowing the preservation process to be carried out more economically. In addition, the loss of wine-based beverages ordinarily occurring during refilling of the wine-based beverage into a second vessel can be reduced. This increases the yield of wine-containing beverages to be treated during preservation. In addition, at least equivalent mixing with the preservatives can be achieved by means of the device according to the invention and the method according to the invention.

### EXAMPLE

### Example 1

The device according to FIG. 1 was used. An ALM-40 from the firm Tellarini, Ravenna, Italy was used as a pump. The pump was connected with flexible hoses to the inlets and outlets of the lines. A T-piece was installed in the hose upstream of the pump, allowing the dimethyl dicarbonate to be aspirated in.

The tube was inserted into the bung hole of a barrique cask, and the space between the tube and the bung hole was sealed with an elastomeric sealant. The distance between the line opening of the inlet, from which the mixture of preservatives and the wine-based beverage flows back into the vessel, and the line opening of the outlet, both of which are located in the wine-based beverage, was 15 cm. The above-described device was used to recirculate 225 l of wine in a barrique cask (volume 225 l) for 10 min. Wine: Alde Gott Vineyard, 2014 Pinot Noir, quality sweet red wine, Baden, with 10.0% alcohol. During the pumping process, the indicated amount of dimethyl dicarbonate (DMDC) was added. 3 samples of the wine (50 ml) were then taken in each case, and after a hydrolysis period of 10 h, the additional amount of MeOH was compared to a blind sample. The methanol content of the wine before dosage was 107 ppm of MeOH.

48 ppm of MeOH is formed from 100 ppm DMDC after hydrolysis.

TABLE 1

| Dosage of DMDC | Calculated | | | |
|---|---|---|---|---|
| Density (DMDC): | amount | Measured amount of MeOH | | |
| 1.25 g/ml | of MeOH | Sample 1 | Sample 2 | Sample 3 |
| 18 ml (100 ppm) | 48 ppm | 46 ppm | 49 ppm | 47 ppm |
| 36 ml (200 ppm) | 96 ppm | 95 ppm | 95 ppm | 94 ppm |

The results confirm uniform introduction and thorough mixing of the wine-based beverages with dimethyl dicarbonate.

1. Method for preserving a wine-based beverage, comprising a vessel (1), at least one line (2), by means of which the wine-based beverage is pumped from the vessel (1) using a pump (3), and at least one storage vessel (4) comprising at least one preservative, characterized in that the preservative is supplied to the wine-based beverage in the line (2) and this mixture is pumped into the same vessel (1).

2. Method according to claim 1, characterized in that the volume of the vessel is 100 l to 2000 l.

3. Method according to claim 2, characterized in that the volume of the vessel is 200 l to 300 l.

4. Method according to claim 1, characterized in that the line opening of the inlet (5), from which the mixture of preservatives and the wine-based beverage flows back into the vessel, and the line opening of the outlet (6) are both in the wine-based beverage.

5. Method according to claim 1, characterized in that the line opening of the inlet (5), from which the mixture of preservatives and wine-based beverage flows back into the vessel, and the line opening of the outlet (6), both of which are located in the wine-based beverage, are at a distance of at least 5 cm from each other, based on the distance between the centres of the openings of the lines.

6. Method according to claim 1, characterized in that dicarbonate diesters are contained as a preservative.

7. Method according to claim 1, characterized in that the preservative is dimethyl dicarbonate or diethyl dicarbonate.

8. Method according to claim 1, characterized in that 1 ppm to 250 ppm of the preservative is added based on the volume of the wine-based beverage.

9. Method according to claim 1, characterized in that the pump has a pumping capacity of 10 l/min to 50 l/min.

10. Method according to claim 1, characterized in that the pumping process is carried out for a period of 10 min to 15 min.

11. Method according to claim 1, characterized in that the liquid of the vessel is completely recirculated by the pump at least once.

12. Device for preserving a wine-based beverage, comprising a vessel (1), at least one line (2), at least one pump (3) and at least one storage vessel (4) comprising at least one preservative, characterized in that the preservative is supplied to the wine-based beverage in the line (2) and this mixture is pumped into the same vessel (1).

13. Device according to claim 12, characterized in that the injection is carried out from the storage vessel (4) into the line (2) by means of an injector (7).

14. Method according to claim 12, characterized in that the injector (7) is a Venturi nozzle.

15. Use of the device according to claim 12 for preserving wine and mixed wine beverages.
